(19) United States
(12) Patent Application Publication
(10) Pub. No.: US 2022/0084091 A1
(43) Pub. Date: Mar. 17, 2022

(54) CONTINUOUS LEARNING FOR SELLER DISAMBIGUATION, ASSESSMENT, AND ONBOARDING TO ELECTRONIC MARKETPLACES

(71) Applicant: MASTERCARD INTERNATIONAL INCORPORATED, Purchase, NY (US)

(72) Inventors: Joel DOHERTY, Maquapit Lake (CA); Benjamin DIDSZUWEIT, London (GB); Jacqueline TILL, New York, NY (US); Nicolas BUC, Larchmont, NY (US); Mohammad Shamroz AEDHEE, Lake Hiawatha, NJ (US); Jennifer PREMISLER, Scarsdale, NY (US); Fred TYLER, Santa Monica, CA (US); James Brian O'CONNELL, New York, NY (US); Maja LAPCEVIC, Long Island City, NY (US); Jonathan TRIVELAS, Stormville, NY (US)

(73) Assignee: MASTERCARD INTERNATIONAL INCORPORATED, Purchase, NY (US)

(21) Appl. No.: 17/476,245

(22) Filed: Sep. 15, 2021

Related U.S. Application Data
(60) Provisional application No. 63/079,844, filed on Sep. 17, 2020.

(51) Int. Cl. G06Q 30/06; G06F 16/28; G06F 16/2457; G06Q 30/02; G06Q 40/02

(52) U.S. Cl. CPC G06Q 30/0609; G06F 16/285; G06Q 40/025; G06Q 30/0201; G06Q 30/0204; G06F 16/24578

(57) ABSTRACT

Systems and computer-implemented methods are described disambiguating seller identities and assessing sellers based on continuous learning. For example, a system may identify and assess sellers across multiple channels such as electronic marketplaces by aggregating data at different time points from one or more sources of data that may each include respective and different seller details known about sellers to learn current information relating to sellers. Because of the different ways in which the sources of data may store and transmit their respective seller details, the system may aggregate the data from the different data sources, disambiguate sellers associated with the aggregated data, and generate a seller response message arranged based on a data structure that uses linkage identifiers that each groups aggregated data predicted to relate to a respective seller.

### RELATED APPLICATIONS

This application claims priority to U.S. Provisional Patent Application Ser. No. 63/079,844, filed on Sep. 17, 2020, which is incorporated herein by reference in its entirety.

### BACKGROUND

Electronic marketplaces serve as a platform for sellers to sell items such as products and/or services. In exchange for providing logistical support, which may include storage, delivery, payment processing, and/or other support for the sellers, electronic marketplaces may charge a seller fee. In addition to logistical support, sellers benefit by gaining access to marketplace consumers, who purchase from electronic marketplaces due to their convenience and established trust. To maintain that trust and also to drive sales, electronic marketplaces may attempt to onboard and retain high quality sellers. However, doing so may be difficult because of the very nature of the ease with which sellers may establish electronic “storefronts” on electronic marketplaces. For example, because of the ease of becoming a seller, true seller identities may be obfuscated. In particular, an individual or entity may establish multiple seller accounts and it may be difficult to disambiguate the source of those multiple seller accounts. Furthermore, an individual or entity may establish seller accounts across multiple electronic marketplaces, either with the same seller names or different ones. This problem is heightened by the fragmented technology stacks, formats, and proprietary data about sellers across different marketplaces. Thus, it may be difficult to disambiguate and assess sellers amongst the massive volumes of data. These and other issues may exist for automatically disambiguating and assessing sellers in electronic marketplaces.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of continuous learning to disambiguate and assess sellers;

FIG. 2 illustrates an example of an orchestrator of server illustrated in FIG. 1;

FIG. 3 illustrates an example of data flow diagram for feedback and continuous learning of the system illustrated in FIG. 1;

FIG. 4 illustrates an example of an architecture of the system illustrated in FIG. 1;

FIG. 5 illustrates a data flow diagram of aggregating data of a seller to model and predict an identity of the seller and/or assess the seller;

FIG. 6 illustrates an example of a method of continuous learning to disambiguate and assess sellers;

FIG. 7 illustrates an example of a method of processing a request to generate a seller certification;

FIG. 8 illustrates an example of a method of processing a request to validate a seller certification;

FIG. 9 illustrates an example of a method of processing a request to automatically onboard to a marketplace;

FIG. 10 illustrates an example of a computer system that may be implemented by devices illustrated in FIGS. 1, 3, and 4;

FIG. 11 illustrates an example of a user interface to display pending applications of sellers applying to join a marketplace;

FIG. 12 illustrates an example of a user interface to display a seller performance report for a high-scoring seller;

FIG. 13 illustrates an example of a user interface to display a seller performance report for a low-scoring seller;

FIG. 14 illustrates an example of a user interface to display a seller detail report for the low-scoring seller illustrated in FIG. 10; and

FIG. 15 illustrates an example of a user interface to display a seller dashboard to be provided to a seller.

### DETAILED DESCRIPTION

The disclosure herein relates to methods and systems of disambiguating seller identities and assessing sellers based on continuous learning. Continuous learning may be used to identify and assess sellers across multiple channels such as electronic marketplaces (hereinafter, simply “marketplaces” for convenience) or other channels through which data about the sellers may be obtained. Continuous learning may refer to aggregating data at different time points from one or more sources of data that may each include respective and different seller details known about sellers to learn current information relating to sellers. Because of the different ways in which the sources of data may store and transmit their respective seller details, a system may aggregate the data from the different data sources, disambiguate sellers associated with the aggregated data, and generate a seller response message. The seller response message may include a particular data structure arranged to group a linkage identifier with corresponding aggregated data predicted to relate to a respective seller. Continuous learning may facilitate discovery and assessment of new sellers, as well as refine assessments of current sellers, based on continuously updated data known about sellers from the one or more sources of data.

In some examples, the one or more sources of data may provide data about sellers known by a payment network, such as the Mastercard® payment network. Because of the global reach, trust, and scale of this and some other payment networks, data from these payment networks may be leveraged to identify and assess sellers. Although sellers may open multiple electronic storefronts on the same or different marketplaces, they may still accept payments through the payment network.

The term disambiguating as used herein may refer to processing two or more data values from at least one data field to determine that they relate to a single individual or entity. In examples described herein, the data fields may include seller details that are known about sellers. For example, disambiguating may include comparing a first seller name to a second seller name. The seller details may be from different sources of data. For example, the first seller name may be from a first source of data and the second seller name may be from a second source of data. Other types of data fields may be compared as well. For example, a first address associated the first seller name may be compared to a second address associated with the second seller name. In this example, both the first seller name and first seller address may be compared to the second seller name and the second seller address to determine whether the first seller name and the second seller name refer to the same seller (or individual or entity associated with the seller). Based on the matching, a level of confidence that the first seller name and the second seller name refer to the same seller may be determined. For example, exact matches between the first seller name, the first seller address, the second seller name and the second seller address may result in the highest level of confidence, partial or some exact matches may result in a moderate level of confidence, while no matches may result in the lowest level of confidence. Other types of data fields, or seller details, may be used for disambiguating as well.

Based on the continuous learning to disambiguate and assess sellers, the methods and systems may be improved to identify sellers (including groups of seller names that correspond to a an individual or entity) whether they use multiple seller names or are associated with other seller details, and assess the quality of the sellers for onboarding and other purposes. The foregoing may mitigate problems with anonymity or ambiguous seller identities.

In some examples, the continuous learning may facilitate generation of seller certificates. A seller certificate may refer to an electronically stored indication that the seller has achieved a trusted status, which may be important to marketplaces and customers. For example, the system may interface with marketplaces so that a seller having a seller certificate may be eligible to automatically be onboarded to the marketplaces. A certified seller may be able to “one-click” join a marketplace that has registered with the system to permit automatic onboarding of certified sellers. The automatic onboarding may be made without human intervention and may result in a seller account being generated for the seller on the marketplace.

To generate seller certificates, a system may apply one or more certification rules that specify certification criteria and evaluate the certification rules against seller details. The certification criteria may include a requirement for seller identity verification, in which a seller achieve seller certification when the identity of the seller is verified, which may be based on the continuous learning. The certification criteria may include other requirements such as sales performance requirements, customer satisfaction requirement, security compliance requirements, and/or other requirements specified by the system and/or marketplaces.

In some examples, the continuous learning may facilitate insights for various entities. For example, marketplaces may benefit by being able to identify and assess sellers that may impact a reputation of the marketplace, as well as enhance seller onboarding and accelerate category or geographic expansion through analysis of seller transactions across geographies, perform competitive benchmarking, consumer, loyalty and other trends, and providing actionable insights. Marketplaces may further benefit by retaining sellers through value-added services such as financial and loyalty program services. Similarly, acquirers may benefit when assessing sellers with whom to be a third-party partner for payment purposes. Sellers may benefit through automated registration (onboarding) processes to join multiple marketplaces, and increase trust, demand and revenue as a certified seller. The system may also provide sellers with data and insights to make decisions and take action, and leverage the value-added services. Technology providers (those who provide technology services for marketplaces and/or sellers) may be able to enhance current offerings through addition of system capabilities. Acquirers may benefit by gaining visibility on a growing segment with important financial and liability risks, as well as competing and growing business.

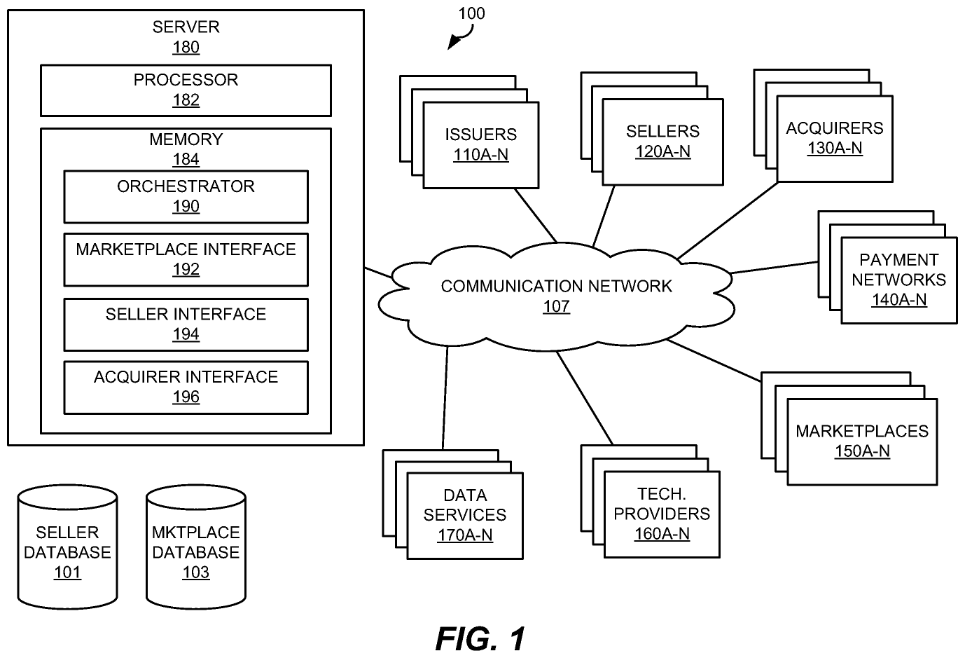

Having described a high-level overview of various functions and operations, attention will now turn to a system to facilitate these and other functions and operations. For example, FIG. 1 illustrates an example of a system 100 of continuous learning to disambiguate and assess sellers. The system 100 may include, among other things, a seller database 101, a marketplace database 103, a server 180, one or more issuers 110 (illustrated as issuers 110A-N), a plurality of sellers 120, one or more acquirers 130 (illustrated as acquirers 130A-N), a payment network 140, a plurality of marketplaces 150, one or more technology (“tech”) providers 160, one or more data services 170 (illustrated as 170A-N), and/or other components. It should be noted that although the server 180 is illustrated as being standalone, the server 180 may be integrated with and be operated by an acquirer 130, a payment network 140, a marketplace 150, a tech provider 160, and/or a data service 170.

The seller database 101 may store information about sellers, including disambiguated sellers, marketplaces 150 on which sellers are active, data aggregated regarding sellers 120, including feedback information from marketplaces 150, data from technology (“tech.”) providers 160, data from data services 170, and/or other data known about the sellers 120. The marketplace database 103 may store information about marketplaces, including onboarding criteria, sellers, information provided from marketplaces, and/or other data known about the marketplaces 150.

An issuer 110 may issue payment cards (such as credit cards and debit cards) each associated with a payment account. Payment card details may be stored in a digital wallet, which may refer to an application executing on a user device to facilitate payment transactions. Accordingly, examples describing payment transactions made via payment cards will also refer to payments made through such a digital wallet.

A seller 120 may receive payments via payment cards through one or more merchant acquirers 130 (acquirers 130), which may communicate with a payment network 140 to obtain authorizations from corresponding issuers 110. As used herein, the term “merchant” will be used interchangeably with the term “seller.” A seller 120 may refer to an individual or entity that sells items (such as goods and/or services) through one or more marketplaces 150, one or more brick-and-mortar locations, individual electronic commerce sites (such as a website of a seller 120), and/or other channels. A given seller 120 may use the same seller name or multiple (different) seller names across different channels. Acquirers 130 may themselves onboard sellers 120 to process payments on behalf of the sellers 120.

A payment network 140 may refer to a computer network that facilitates payment transactions between sellers 120 and issuers 110. A payment network 140 such as the Mastercard® network may have access to global purchase-related data of sellers 120 that submit payment transactions over the payment network 140. Accordingly, the payment network 140 may have the scale, network, trust, data, and assets to facilitate data aggregation relating to sellers 120.

In some examples, the payment network 140 may provide one or more of the data services 170. In these examples, one or more of the data services 170 may provide transaction-related data on sellers 120, regardless of which channel the sellers 120 use to sell items. Each of the data services 170 may provide different information on sellers 120. For example, some or all of the data services 170 may be based on underlying acquirer-provided data, payment transaction data, and/or other sources of data accessible to or generated by the payment network 140.

A data service 170A may include a risk data service that identifies risky sellers 120. The risk data service may be based on information provided by acquirers 130 and/or other entities that may have knowledge of risk factors of sellers 120 known to the entities. For example, acquirers 130 may provide information relating to risk behaviors of the sellers 120 for which they provide payment services. In particular, the risk data service may maintain a listing of sellers 120 that have been reported to exhibit risky behavior. One example of a risk data service includes the Mastercard® Member Alert To Control High-risk merchants (MATCH) system. The MATCH system may receive reason codes that explain why a seller 120 is being reported to the MATCH system. For example, reason codes may include, without limitation, account data compromise, common point of purchase, laundering, excessive chargebacks, excessive fraud, fraud conviction, questionable merchant audit program, bankruptcy/liquidation/insolvency, violation of payment network standards, merchant collusion, Payment Card Industry (PCI) data security standard noncompliance, illegal transactions, identity theft, and/or other reasons. A seller 120 that is stored in the MATCH system may be associated with one or more of the foregoing reason codes and therefore may be deemed a risky seller.

A data service 170B may include a merchant tool (MT) data service that identifies sellers 120 registered to receive payments through a payment network 140. The MT data service may therefore provide an identity of sellers 120. One example of the MT data service includes the Mastercard® Merchant Tool (MMT).

A data service 170C may include a merchant identifier (MI) data service that provides rich merchant data regarding sellers 120 based on the sellers' name provided by an acquirer 130. The MI data service may include recognizable merchant descriptors and location information, including merchant “Doing Business As” (DBA) name, merchant category code (MCC), street address, city, state, postal code, country, and sales channels. One example of the MI data service includes the Mastercard® Merchant Identifier. For instance, querying “CAFETERIA 123456” (a descriptor found on a cardholder statement), may produce: Merchant Category: 5814—FAST FOOD RESTAURANTS Merchant DBA Name: CAFETERIA 123456 Street: 123 Main Street City: Anytown State: Anystate Postal Code: 12345 Country: USA—UNITED STATES Sales Channels: Brick 100%.

A data service 170D may include a transaction data service that provides purchase transaction information relating to sellers 120 that requested payments through a payment network 140. In some examples, the transaction data service may use a seller identifier output by the MT data service and/or the MI data service. Thus, the MT data service and/or the MI data service may be used to identify the seller identifier based on details such as seller name. The seller identifier may then be used as input to the transaction data service to retrieve transaction information for the seller 120 identified by the seller identifier. One example of the transaction data service includes the Mastercard® Small Business Development Enhancer (SBDE), which may use a unique Mastercard® Merchant Hierarchy Identifier (MMHID) as the seller identifier.

It should be noted that other data services 170 may provide other types of data that those data services 170 know about sellers 120. For example, the data services 170N may include credit bureaus, business identity and analytics systems (such as DUN & BRADSTREET DUNS numbers), and/or other sources that may store information about sellers 120.

A marketplace 150 may refer to a computer platform that sellers 120 may use to provide items (products and/or services) to customers via a communication network 107. Examples of marketplaces 150 include electronic commerce platforms used by sellers to sell products that may be delivered or downloaded, platforms used by sellers to provide services (assembly or installation services, driver or other “gig” economy services), sellers that provide financial products/services, and/or other items that may be sold by third-party sellers using the marketplace. The computer platform may refer to one or more computing devices, databases, logic, and/or other computer components that facilitate purchases of products and/or services between third-party sellers and consumers.

A tech provider 160 may refer to a service of an entity that provides technology solutions for marketplaces 150 and/or sellers 120. For example, a tech provider 160 provide device identity solutions that identify devices of sellers 120 or principals of the sellers 120, Know Your Customer (KYC) services that track or verify contact information such as electronic mail, phone, and address, individual identity solutions such as document and biometric verification services, seller onboarding solutions, cyber security services that monitor a security posture of entities such as sellers 120, and/or other types of technology providers. The data known and provided by the tech providers 160 may be referred to as “technology data” or “tech data”.

The server 180 may include a processor 182, a memory 184, an orchestrator 190, a marketplace interface 192, a seller interface 194, an acquirer interface 196, and/or other components. The processor 182 may be a semiconductor-based microprocessor, a central processing unit (CPU), an application specific integrated circuit (ASIC), a field-programmable gate array (FPGA), and/or other suitable hardware device. Although the server 180 has been depicted as including a single processor 182, it should be understood that the server 180 may include multiple processors, multiple cores, or the like. The memory 184 may be an electronic, magnetic, optical, or other physical storage device that includes or stores executable instructions. The memory 184 may be, for example, Random Access memory (RAM), an Electrically Erasable Programmable Read-Only Memory (EEPROM), a storage device, an optical disc, and the like. The memory 184 may be a non-transitory machine-readable storage medium, where the term “non-transitory” does not encompass transitory propagating signals. The orchestrator 190, the marketplace interface 192, the seller interface 194, and/or the acquirer interface 196 may each be implemented as instructions that program the processor 182. Alternatively, or additionally, the orchestrator 190, the marketplace interface 192, the seller interface 194, and/or the acquirer interface 196 may each be implemented in hardware.

The orchestrator 190 may perform various operations to disambiguate, assess, and certify sellers 120, provide data mining results for sellers 120, acquirers 130, marketplaces 150, and/or provide other functions described herein. For example, the orchestrator 190 may aggregate data from the various sources of data to disambiguate sellers 120 from among the aggregated data. An example of aggregated data is provided in Table 1 for illustration.

TABLE 1
Aggregated Metrics and Data

| # | Attribute Name | Description |
|---|---|---|
| 1 | Total Transaction | Total spend on all transactions across all marketplaces (or all |
| | Spend ($) | channels) |
| 2 | Total Number of | Total number of transactions at Seller |
| | Transactions (#) | |
| 3 | Brick Channel - % | % of spend at Seller that is recorded as a brick transaction |
| | spend | |
| 4 | Brick Channel - % | % of transactions at Seller that is recorded as a brick transaction |
| | transactions | |
| 5 | Online Channel - % | % of spend at Seller that is recorded as an online transaction |
| | spend | |
| 6 | Online Channel - % | % of transactions at Seller that is recorded as an online transaction |
| | transactions | |
| 7 | Card Type - Debit - | Breakdown of % of spend at Seller by card type - debit |
| | % spend | |
| 8 | Card Type - Debit - | breakdown of % of transactions at Seller by card type - debit |
| | % transactions | |
| 9 | Card Type - Credit - | breakdown of % of spend at Seller by card type - credit |
| | % spend | |
| 10 | Card Type - Credit - | breakdown of % of transactions at Seller by card type - credit |
| | % transactions | |
| 11 | Average Frequency | Average number of transactions per Seller customer accounts |
| | (#) | |
| 12 | % Repeat customers | 2+ purchases in past 1 month |
| | (30 days) | |
| 13 | % Repeat customers | 2+ purchases in past 2 months |
| | (60 days) | |
| 14 | % Repeat customers | 2+ purchases in past 3 months |
| | (90 days) | |
| 15 | Card Product - | % of spend at Seller by top predefined card types |
| | Annual Spend Index | |
| 16 | Card Product - | % of transactions at Seller by top predefined card types |
| | Average Ticket | |
| | Index | |
| 17 | Card Profile - | Average annual spend on card indexed to the average annual spend on |
| | Annual Spend Index | all cards in a payment network |
| 18 | Card Product - | Average ticket size on card indexed to the average ticket size on all |
| | Average Ticket | cards in a payment network |
| | Index | |
| 19 | Card Product - | Average number of transactions on card indexed to the average |
| | Annual Purchases | number of transactions on all cards in a payment network |
| | Index | |
| 20 | MMHID | Seller Market Hierarchy ID, used as a matching key |
| 21 | Seller Name | Scrubbed Seller name from transaction clearing data |
| 22 | Cleansed Seller | Cleansed name (after cleansing and third-party data validation |
| | Name | process) |
| 23 | Address | Scrubbed Seller address from transaction clearing data |
| 24 | Address (Cleansed) | Cleansed address (after cleansing and third-party data validation |
| | | process) |
| 25 | City Name | Scrubbed Seller city from transaction clearing data |
| 26 | City Name | Cleansed city (after cleansing and third-party data validation process) |
| | (Cleansed) | |
| 27 | State Name | Scrubbed Seller state/county from transaction clearing data |
| 28 | State Name | Cleansed state/county (after cleansing and third-party data |
| | (Cleansed) | validation process) |
| 29 | Postal Code | Scrubbed Seller postal/ZIP code from transaction clearing data |
| 30 | Postal Code | Cleansed postal/ZIP code (after cleansing and third-party data |
| | (Cleansed) | validation process) |
| 31 | Country Code | Scrubbed Seller country code from transaction clearing data |
| 32 | Country Code | Cleansed country code (after cleansing and third-party data |
| | (Cleansed) | validation process) |
| 33 | Phone Number | Cleansed telephone number (after cleansing and third-party data |
| | | validation process) |
| 34 | Phone Number | The Seller phone number after it has been cleaned via matches to |
| | (Cleansed) | third party data |
| 35 | Seller Category | Seller Category Code as reported in the transaction clearing record. |
| | Code (MCC) | |
| 36 | Legal Corporate | The Seller legal name as it appears in the clearing record |
| | Name | |
| 37 | Legal Corporate | The Seller legal name as it appears after it has been cleaned via |
| | Name (Cleansed) | matches to third party data |
| 38 | Industry | Payment network-defined grouping of Seller Category Codes |
| 39 | Super Industry | Payment network-defined grouping of Seller Category Codes |
| 40 | DUN & | Seller's DUN & BRADSTREET NUMBER |
| | BRADSTREET | |
| | NUMBER | |
| 41 | Date Established | First date of transaction seen at Seller |
| 42 | Last Seen Date | Date of last transaction seen at Seller as of report date |
| 43 | New Business | Indicates whether the location is a ‘new business' based on the |
| | | presence of a first transaction in the preceding 30 days. (True/False) |
| | | indicator |
| 44 | Aggregate Seller | Name of the Seller aggregate chain |
| | Name | |
| 45 | Aggregate Seller ID | Groups Seller locations by chain. First level of aggregation |
| 46 | Key Aggregate | Joins together different channels under the same chain. Second level |
| | Seller ID | of aggregation |
| 47 | Parent Aggregate | ID code of the parent aggregate |
| | Seller ID | |
| 48 | Parent Aggregate | Name of the parent aggregate |
| | Seller Name | |
| 49 | NAICS code | Seller NAICS code |
| 50 | Refund Performance | Percentage of transactions across all Seller channels flagged as |
| | | REFUNDS (could include total transaction value as well) |
| 51 | Returns | Percentage of transactions across all Seller channels flagged as |
| | Performance | RETURNS (could include total transaction value as well) |
| 52 | Chargeback | Percentage of transactions across all Seller channels flagged as |
| | Performance | CHARGEBACKS (could include total transaction value as well) |

The orchestrator 190 may assess sellers 120 based on the aggregated data, provide one-time certification of the sellers 120, provide analytics of sellers and marketplaces, and/or perform other functions. The resulting outputs may be provided to various parties through respective interfaces. For example, the marketplace interface 192 may provide resulting outputs specifically targeted for marketplaces 150. The seller interface 194 may provide resulting outputs specifically targeted for sellers 120. The acquirer interface 196 may provide resulting outputs specifically targeted for acquirers 130. The marketplace interface 192, the seller interface 194, and the acquirer interface 196 may each include Application Programming Interfaces (APIs) for programmatic access to the resulting outputs, user interfaces for human access to the resulting outputs, and/or other types of interfaces.

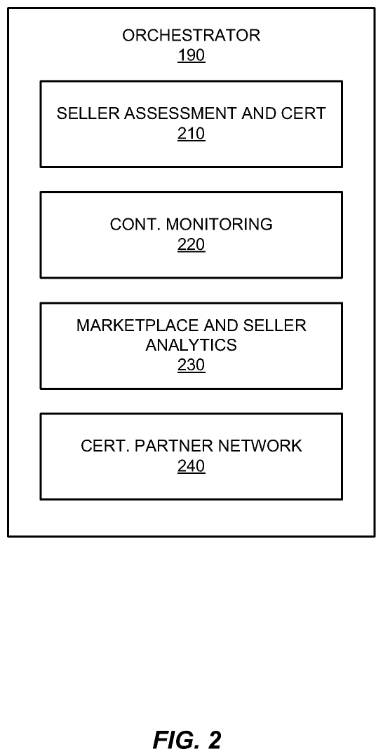

Referring to FIG. 2, the orchestrator 190 may include various blocks, which may include subroutines, software libraries, or other logic that programs the processor 182. In some examples, the various blocks may each be implemented in hardware. Regardless of the particular implementation, the various blocks of the orchestrator 190 may include a seller assessment and certification 210 block, a continuous monitoring and learning 220 block, a marketplace and seller analytics 230 block, a certified partner network 240 block, and/or blocks. It should be noted that the various blocks may be integrated with one another and may not necessarily be discrete blocks.

Disambiguation, Assessment, and Certification

The seller assessment and certification 210 block may aggregate data from one or more sources of data to identify, assess, certify, and/or perform other operations with respect to sellers 120. The sources of data may include the data services 170, the tech providers 160, the marketplaces 150, and/or other sources that may have information relating to sellers 120.

To identify a given seller 120, the seller assessment and certification 210 block may provide known details of the seller 120 to the data services 170, the tech providers 160, the marketplaces 150, and/or other sources. Such known details may include a seller name (used by the seller 120), address, phone number, principal name (name of a principal of the seller 120), principal address, principal phone number, and/or other known details. Matching results from the data services 170, the tech providers 160, the marketplaces 150, and/or other sources may be aggregated to identify the seller 120. Such matching results may be referred to as “candidate sellers” because the matching results may indicate an identity of the seller 120 based on information provided to the data services 170, the tech providers 160, the marketplaces 150, and/or other sources.

To illustrate, a match between a detail of the seller and a detail of a candidate seller may include an exact match, a phonetic match, or a partial match. To illustrate, in the examples that follow, assume that the one or more details of the seller includes a seller name “ABC Candy Shop.” An exact match may refer to a match in which there is no deviation. In this example, a seller whose name is “Jaceys Candy Shop” is to be identified and/or assessed. A data service 170A may have a data record for a seller name “ABC Candy Shop.” In this case, the data service 170A may have and provide data of a known seller whose name exactly matches the input seller name of a seller that is to be identified and/or assessed. A phonetic match may refer to a non-exact match but one that is phonetically similar. For example, a data service 170B may have a data record for a seller name “Aybeecee Candy Shop.” In this case, the data service 170B may have and provide data of a known seller whose name phonetically matches the input seller name of a seller that is to be identified and/or assessed. A partial match may refer to a non-exact and non-phonetic match in which a portion of a seller detail matches a detail of a known seller (or vice versa). For example, a data service 170C may have a data record for a seller name “ABC Candy” or “ABC Cndy.” Only portions of the detail may match. In this case, the data service 170C may have and provide data of a known seller whose name partially matches the input seller name of a seller that is to be identified and/or assessed. It should be noted that such partial matches may be scored according to a similarly metric, such as a word distance metric that scores a similarity between words or phrases. Such partial match score may be determined to be a partial match when the partial match score exceeds a predefined threshold. Thus, “ABC Candy” may be deemed to be a partial match to “ABC Candy Store” while “ABC Wines” may not. It should be further noted that other types of details of a seller to be identified and/or assessed may be exactly, phonetically, or partially matched against corresponding details of known sellers. For example, an address, type of goods, and/or other type of detail may be exactly, phonetically, or partially matched against corresponding details of known sellers. The phonetic and partial matching may be able to tolerate typographical and other errors in data records from the data services.

In some examples, the seller assessment and certification 210 block may generate a score for the seller 120 based on the aggregated data. For example, the score may be based on a level of confidence that the seller 120 has been identified. The level of confidence may be based on a confidence indication from the data services 170, the tech providers 160, the marketplaces 150, and/or other sources that the candidate seller is in fact the seller 120. In some examples, the level of confidence may be based on a number of matching seller details and/or types of matches (such as exact, phonetic, and partial), and/or other confidence metric. In some examples, the score may be based on feedback regarding candidate sellers from various entities, such as marketplaces 150, acquirers 130, customers (such as customer reviews), and/or others that interacted with the candidate sellers. In some examples, the scores may be based on data from the data services 170, such as risk level, transaction data (in which a higher number and/or value of transactions may result in a higher score compared to a lower number and/or value of transactions), credit worthiness data, technology posture, and/or other information known about the candidate sellers. In some examples, a composite score for the seller 120 may be generated based on any of the foregoing scores. For example, the composite score may include a weighted score of one or more of the foregoing scores. In these examples, weights for each score may be adjusted based on one or more factors, such as the category of items that the candidate seller sells.

In some examples, the seller assessment and certification 210 block may generate a seller certification for a seller 120. The seller certification may be identified by a certification identifier stored in association with identifying information of the seller 120 in the seller database 101. Thus, seller certifications may be looked up and verified based on the certification identifier and/or identifying information of the seller 120.

In some examples, the seller assessment and certification 210 block may generate the seller certification based on one or more certification rules that are applied by the server 180. The one or more certification rules may specify one or more certification criteria. The one or more certification criteria may include a requirement that the seller 120 be identified with a threshold level of confidence, that the seller's 120 transactions be validated (such as to ensure that the number and/or value of the transactions exceeds a threshold number or value), the seller 120 has one or more scores above respective threshold values, the seller 120 has a composite score above a composite threshold value, and/or other criteria.

If the seller 120 is certified, the seller assessment and certification 210 block may provide the seller 120 with the certification identifier, text indicia, and/or graphical indicia of such certification. The seller 120 may then display the certification identifier, text indicia, and/or graphical indicia on an online and/or brick-and-mortar location to establish trust with customers. In some examples, the seller assessment and certification 210 block may transmit the seller certification to other parties as well, such as to marketplaces 150.

In some examples, seller certification may expedite the onboarding process for a marketplace 150 that is assessing the seller 120. In some examples, the seller certification may facilitate one-click onboarding in which a seller 120 having a seller certification may be eligible to one-click onboarding onto a marketplace 150 (which may agree to participate in such one-click onboarding). One-click onboarding may include storing information required by the participating marketplace 150. For example, the marketplace 150 may require certain information be provided by the server 180 before one-click onboarding. The information may include some or all data aggregated by the server 180 and/or other data about the seller 120.

Continuous Monitoring and Learning Systems

The continuous monitoring and learning 220 block may re-assess sellers 120 periodically on schedule, based on an occurrence of a triggering event (such as new data) from one or more sources of data (such as data service 170, tech provider 160, marketplace 150), and/or on-demand by request. For example, the continuous monitoring and learning 220 block may periodically aggregate data from the one or more sources of data, re-assess a seller 120, and the re-assessment to relevant parties, such as marketplaces 150. Such re-assessment may include new scores and/or new composite score, newly aggregated data, and/or other information from the re-assessment. In some examples, the continuous monitoring and learning 220 block may monitor alerts from the one or more sources of data. For example, if a seller 120 is added to the risk data service, then continuous monitoring and learning 220 block may identify relevant parties that are associated with the seller 120, and transmit an alert including any reason codes to the relevant parties. In particular, a relevant party may include a marketplace 150 that has onboarded or is assessing a seller 120. Other types of alerts may be similarly monitored, such as transaction alerts (indicating volume of transactions), security alerts (indicating security posture or intrusions), and feedback alerts (indicating negative feedback from marketplaces 150 and/or customers).

Data Mining Outputs

The marketplace and seller analytics 230 block may provide various entities with analytics relevant to their business. For example, the marketplace and seller analytics 230 block may provide marketplace analytics, seller analytics, and/or other types of analytics. Such analytics may be driven by rules that define data processing.

For example, marketplace analytics may provide marketplaces 150 with data that categorizes sellers 120 to analyze whether to onboard, retain, drop, invest in, or otherwise to decide on what to do with a given seller 120. In a particular example, Table 2 provides a categorization matrix that represents rules to categorize sellers 120. In some examples, the marketplace analytics may include regional and category views that may identify new sellers to onboard by geography and category based on seller benchmarking (with respect to other sellers and industries).

TABLE 2
Categorization Matrix. Such categorization may assist marketplaces
150 to understand purchase patterns uniquely derived from the
aggregated data, and guides their acquisition and retention
efforts. It should be noted that the data presented in Table
2 is provided for illustrative, and not necessarily limiting,
purposes. It should be further noted that some of all of the
matrix below may be used to score sellers 120 as well.

| | | | |
|---|---|---|---|
| Heavy spend in | Primary Target | Increase Loyalty | Retain, Grow, |
| industry | | | Delight |
| Medium spend | Secondary | Increase Loyalty | Trade Up |
| in industry | Target | | |
| Light spend in | Low investment | Low investment | Trade Up |
| industry | | | |
| | Low spend with | Medium spend | High spend |
| | seller | with seller | with seller |

The seller analytics may provide a view of the business across multiple channels (which may include multiple marketplaces 150), including which channels are outperforming and/or which channels that the seller 120 should be on. The seller analytics may provide a holistic view of seller performance across all active channels built on a broad range of data, as well as buyer data, supporting analysis, benchmarking share of wallet, and combined in actionable insights.

In some examples, the marketplace and/or seller analytics may include test and learning analytics in which the impact of an action or activity may be assessed for data-based performance optimization. For example, the effect of a new marketing campaign, new types of items to sell, new types of sellers 120 to onboard, and/or other actions or activities may be assessed based on the aggregated data.

Partner Network

The partner network 240 block may facilitate interactions with various services that may be accessed by sellers 120 and marketplaces 150. For example, the partner network 240 block may provide interaction with services that provide access to capital, technology infrastructure (such as Software as a Service providers), loyalty platforms, and/or other services to drive loyalty to respective customers.

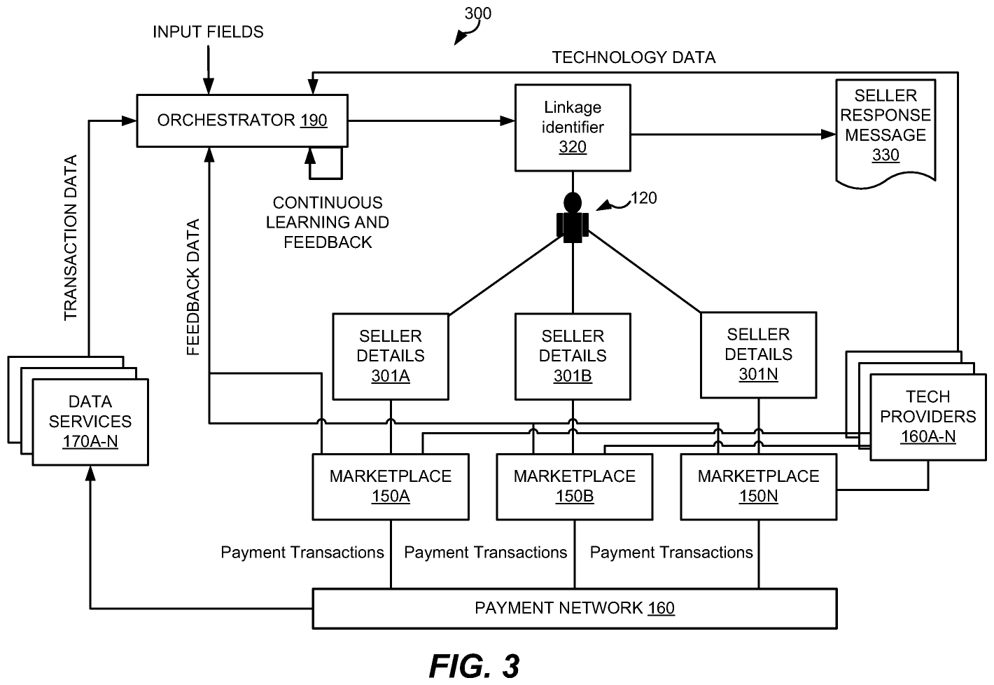

FIG. 3 illustrates an example of data flow diagram 300 for feedback and continuous learning of the system 100 illustrated in FIG. 1. As illustrated, a seller 120 may sell items through various marketplaces 150A-N. Although not illustrated, the seller 120 may also sell items through brick-and-mortar locations and through its own electronic commerce site.

The marketplaces 150A-N may have onboarded the seller 120 with respective seller details 301A-N. Some or all of the seller details 301 may match, partially match, or not match one another. For example, a seller detail 301A that includes a first seller name on the marketplace 150A may match, partially match, or not match a seller detail 301B that includes second seller name on the marketplace 150B. The marketplaces 150A-N may each have onboarded the seller 120 with respective seller details 301. The marketplaces 150A-N may process payments from customers on behalf of the seller 120 and transmit the payment (minus marketplace fees) to the seller 120 via the payment network 140, which may provide transaction data through the data services 170A-N. The transaction data may include data regarding the seller derived from purchase transactions submitted via the payment network 140, such as amount of time in business, channel breakdown, seller's revenue (and trend over the last 12 months), number of sales (and trend over the last 12 months), location of sales (and trend over the last 12 months), average spend per sale, average number of sales per customer, chargebacks over the past year, refunds over the past year, repeat customers over the last month, and/or other transaction data.

The marketplaces 150A-N may also provide feedback data, such as customer reviews of the seller 120, return data indicating number or rate of item returns of the seller 120, assessment of the seller 120 from a marketplace operator (not from a customer of the seller), seller legal name, seller full address (address, city, state/province, country, zipcode), principal owner name, first name, last name, and/or other feedback data that a marketplace 150 may share through the server 180 (via the orchestrator 190). The tech providers 160 may provide services to the marketplaces 150A-N and may also provide technology data regarding the seller 120. In some examples, the feedback data and/or the technology data may be provided to the orchestrator 190 via response code that encode the feedback data and/or the technology data. Such response codes may leverage payment network 140 data encodings to transmit data over the communication network 107.

To identify and/or assess a seller 120, the orchestrator 190 may receive one or more input fields that specify details about the seller 120. The input fields may be provided by a marketplace 150 that wishes to assess the seller 120, by the seller 120 that wishes to obtain seller certification or seller analytics, and/or other entities. The input fields may include a merchant legal name, merchant DBA, address line 1, address line 2, address city, address state, address province, address post code, address country, phone number, Tax ID, URL, Principal details (name, address, phone, national ID), and/or other information known about the seller 120 to be identified and/or assessed. The orchestrator 190 may aggregate the transaction data, the feedback data, the technology data, and/or other data (such as from credit bureaus) and assign a linkage identifier 320 for linking together the aggregated data that is predicted to relate to a seller 120. Such predictions may be based on exact matches, partial matches, or phonetic matches to the aggregated data.

The linkage identifier 320 may refer to a system-generated identifier using a globally unique identifier generator (which may use a random number generator), and/or other type of computer-generated identifier. Storage of the linkage identifier 320 in association with the aggregated data may indicate that the aggregated data is predicted to relate to the seller 120 even though the seller 120 may have different seller details 301A-N across different marketplaces 150A-N. Thus, the linkage identifier 320 may disambiguate sellers 120 across multiple marketplaces 150A-N. In some examples, the orchestrator 190 may receive the transaction data, the feedback data, the technology data, and/or other data at various times and generate and update a seller response message 330 regarding the seller 120. In this sense, the orchestrator 190 may continuously learn and incorporate new data regarding the seller 120 through the linkage identifier 320. The seller response message 330 may include the linkage identifier 320, some or all of the aggregated data, one or more scores generated for the seller, a composite score generated for the seller, and/or other data that is predicted to refer to the seller 120. For example, the seller response message 330 may include the merchant legal name, merchant DBA, merchant address, phone, tax ID, URL, principal, MCC, Merchant acquirer ID, MMHID, DUNS, termination code/date, confidence, matched fields, last activity date, cleansed data, indicators, performance data, and/or other aggregated data.

An example of the seller response message is provided in Table 3 below for convenience. It should be noted that the data presented in Table 3 is provided for illustrative, and not necessarily limiting, purposes. It should be further noted that some of all of the matrix below may be used to score sellers 120 as well.

TABLE 3
Example seller response message.

linkage identifier: bad6d7ba-d67a-4ece-a810-aec12f8c11f4
confidence level: HIGH
score: 78%
terminationCode: 04
terminationDate: 2020/07/30
matchedMerchant {
name: “ABC CANDY STORE”

...

address “123 Main Street, Anytown, USA”

principals [ ]

}
matchedFields {

name: “EXACT”,
address: “EXACT”

},
peformance {

“hiddenGem”: ‘true”

}

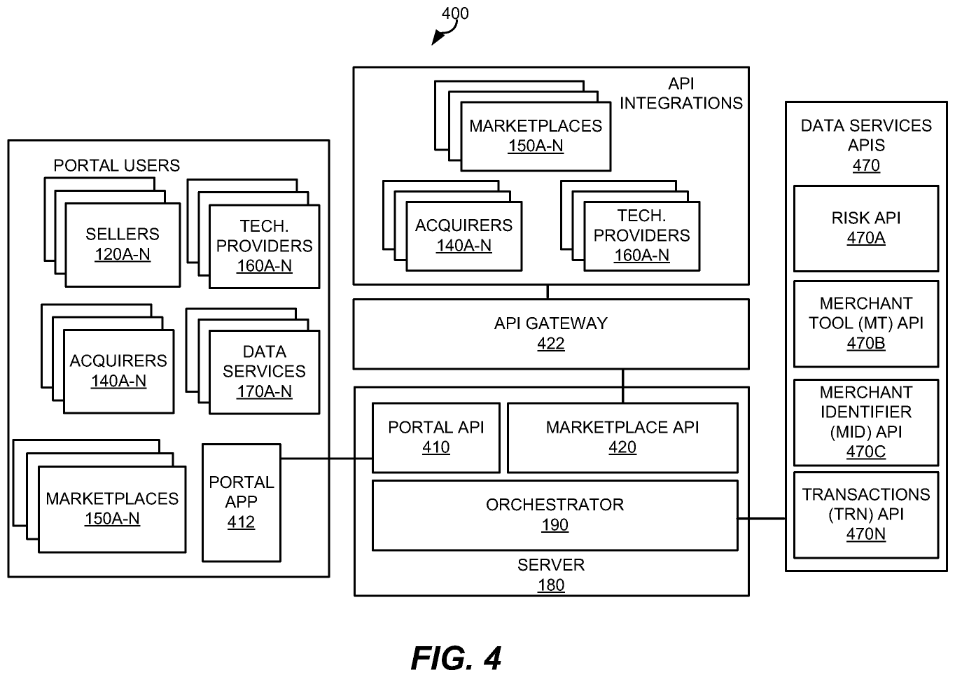

FIG. 4 illustrates an example of an architecture 400 of the system 100 illustrated in FIG. 1. As illustrated, one or more entities, such as acquirers 130, marketplaces 150, and tech providers 160 may integrate Application Programming Interfaces (APIs) into their computing devices (or applications executing on their computing devices). The API integrations may make API calls to an API gateway 422, which may interface with a marketplace API 420 that provides messaging to and message response from the orchestrator 190. Such message response may include some or all of the seller response message 330 illustrated in FIG. 3.

The marketplace API 420 may implement a REpresentational State Transfer (REST) with OpenAPI 3 interfaces. Other types of APIs and interfaces may be used as well. In some examples, the marketplace API 420 may employ a microservices architecture in which calls and applications may be individually implemented. One example of such a microservices architecture includes the SPRING BOOT architecture, although others may be used as well. The marketplace API 420 may implement security through Auth-based and/or other authentication techniques.

In some examples, the architecture 400 may provide interfaces for portal users (not applications). Portal users may include users acting on behalf of various entities such as sellers 120, acquirers 130, marketplaces 150, tech providers 160, data services 170, and/or other users that may use a portal application (“app”) 412. The portal app 412 may execute on or include an application executing on a user device (not shown). The portal app 412 may interface with a portal API 410, which may include services and interfaces through the portal app 412.

The orchestrator 190 may make API calls or otherwise interface with various data services APIs 470 to retrieve data. For example, the orchestrator 190 may interface with a risk API 470A that provides access to the data service 170A, an MT API 470B that provides access to the data service 170B, an MID API 470C that provides access to the data service 170C, a TRN API 470N that provides access to the data service 170N, and/or other interfaces for other data services 170.

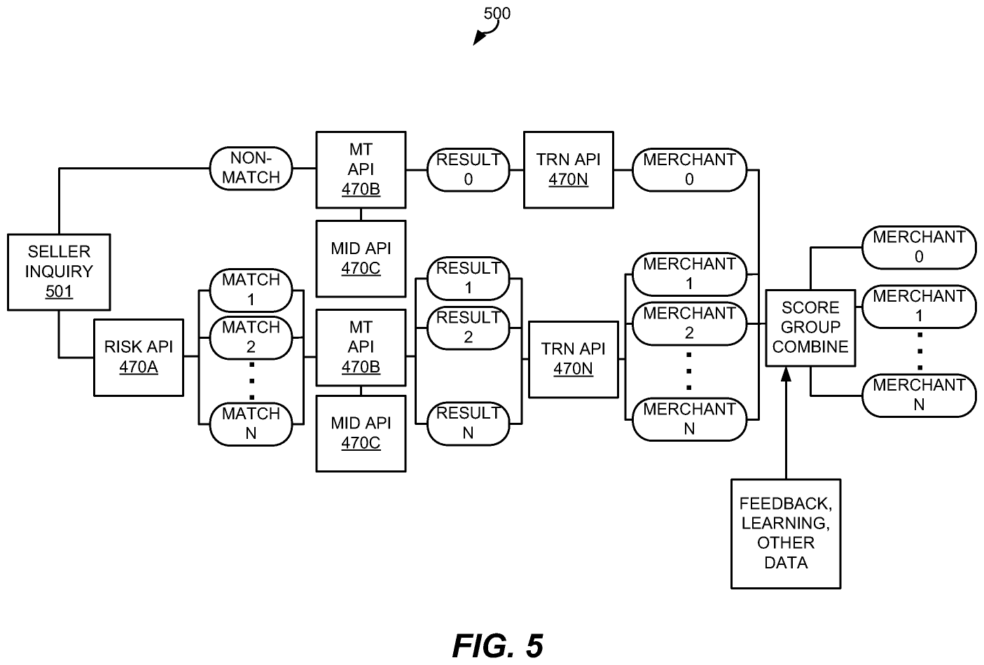

FIG. 5 illustrates a data flow diagram 500 of aggregating data of a seller 120 to model and predict an identity of the seller and/or assess the seller. As illustrated, the data flow may begin upon receipt of a seller inquiry 501. As processing proceeds through the data flow, data about the sellers in the seller inquiry 501 may be enriched by various sources of data. As will be illustrated, the seller inquiry 501 may include multiple sellers to be identified and/or assessed, although only a single seller may be included in a seller inquiry. The seller inquiry 501 may include one or more details of each of the sellers 120. Although other types of seller details may be used, the following examples will use seller names as seller details. The seller name of each of the sellers in the seller inquiry 501 may be provided for input to the risk API 470A. Matches (including exact, partial or phonetic matches) returned from the risk API 470A may indicate that the matching sellers are risky as explained by one or more reason codes. In other words, if a seller name in the seller inquiry 501 matches, then a seller with that seller name may be deemed to be risky. On the other hand, if a seller name in the seller inquiry 501 does not have any returned matches from the risk API 470A, then a seller with that seller name is not known by the data service 170B to be risky. Matching sellers may be referred to as candidate sellers because they may be corresponding sellers.

As illustrated, matches 1-N of the seller names in the seller inquiry 501 were returned from the risk API 470A. These matches 1-N correspond to sellers in the seller inquiry 501 that may be risky based on the data returned from risk API 470A (depending on whether or not the matches 1-N actually correspond to the seller names). A non-match is also illustrated in which case a seller name in the seller inquiry 501 did not have a matching result from the risk API 470A. Other numbers of seller names in the seller inquiry 501 may have non-matches as well. The seller names from the matches 1-N and non-match may be transmitted to the MT API 470B and/or the MID API 470C. In some instances, the seller names from the seller inquiry 501 may be used by the MT API 470B and/or the MID API 470C to identify an identifier used by the payment network 140 to identify its registered sellers 120. Such identifiers may include a MMHID or other identifier used by the payment network 140. In some examples, results 0-N may be returned from the MT API 470B and/or MID API 470C. The results 0-N may include additional details known by the MT API 470B and/or MID API 470C about the candidate sellers, thereby further enriching data known about sellers in the seller inquiry 501. In some examples, results 0-N may represent sellers identified based on seller names or other seller details. In some examples, the results 0-N may include identifiers used by the payment network 140 to identify its registered sellers. Such identifiers and/or seller names from the seller inquiry 501 may be used as input to other sources of data. For example, the identifiers used by the payment network 140 may be provided as input to the TRN API 470N, which may used the identifiers to look up transaction and other data from the sellers identified by the identifiers. The TRN API 470N may output results for merchant 0-N, which may further enrich data known about the sellers of the seller inquiry 501 with transaction and other data. Other types of sources of data, such as feedback data, technology data, and/or other data may further enrich the data known about the sellers.

Processing may flow to score, group, and combine data aggregated from the various sources of data. For example, the aggregated data may be grouped and combined to correspond to a given seller. Each grouping of aggregated data may therefore represent data aggregated for a seller in the seller inquiry 501. Each seller may be scored, cumulatively score, and/or otherwise assessed based on the grouping of aggregated data corresponding to each seller.

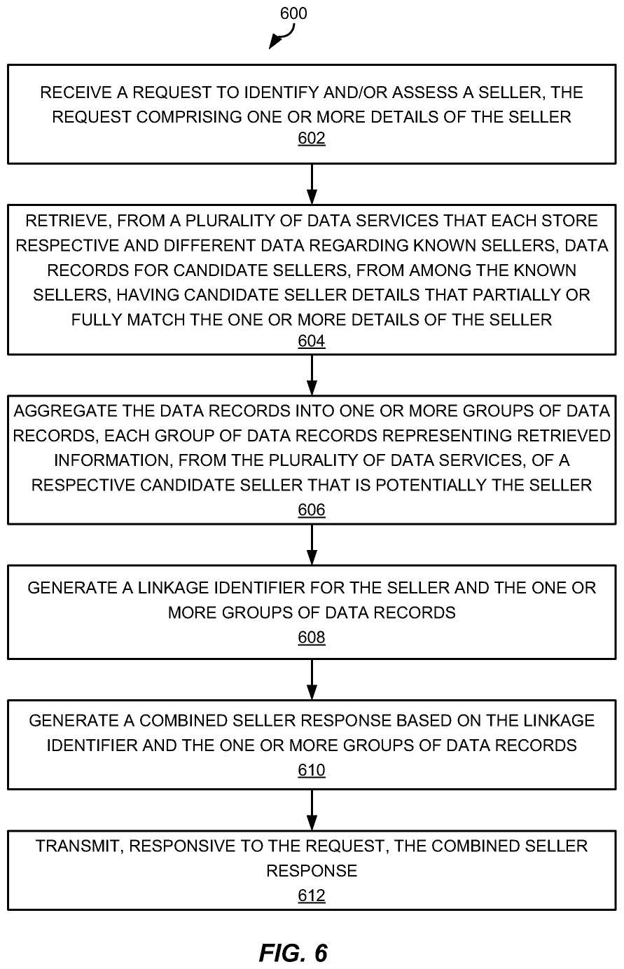

FIG. 6 illustrates an example of a method 600 of continuous learning to disambiguate and assess sellers. The method 600 will be described with reference to FIG. 1 for illustration. At 602, the method 600 may include receiving a request to identify and/or assess a seller (such as a seller 120). The request may include one or more details of the seller. For example, the one or more details may include information known about the seller, which may be reported by the seller and/or obtained from other sources. The one or more details may be used to disambiguate an identity of the seller.

At 604, the method 600 may include retrieving, from a plurality of data services (such as data services 170) that each store respective and different data regarding known sellers, data records for candidate sellers, from among the known sellers, having candidate seller details that partially or fully match the one or more details of the seller. A candidate seller may refer to a known seller that may be the seller that is the subject of the request. In other words, a candidate seller is one that the server 180 may predict is the seller. If a given candidate seller is determined to be the seller, an identity of the seller may be referred to as being disambiguated by virtual of identifying the seller.

At 606, the method 600 may include aggregating the data records into one or more groups of data records, each group of data records representing retrieved information, from the plurality of data services, of a respective candidate seller that is potentially the seller. For example, each group of records may include a data record from each of one or more data services relating to a respective candidate seller. To illustrate, the one or more details of the seller may include an address of the seller. A first data service may provide a first data record that is associated with an exact match for the address and a second data service may return a second data record that is associated with a partial match for the address. In other words, the first data record may include first data of a seller known by the first data service to have an exact match with the address and the second data record may include second data of a seller known by the second data service to have a partial match with the address. Because the first data service may store different data about sellers than the second data service, a grouping of the first data record and the second data record may provide different insights candidate sellers that may in fact be the seller based on the exact or partial matches to the one or more details of the seller.

At 608, the method 600 may include generating a linkage identifier for the seller and the one or more groups of data records. The linkage identifier may include a system-generated identifier that is used for the seller and associated aggregated data records. Thus, the linkage identifier may link together the seller and data records of one or more candidate sellers that may be the seller. The system-generated identifier may be generated using a random-number generator and/or other unique identifier generators. In some examples, the linkage identifier may be used to uniquely identify a seller that may be known by multiple seller identifiers across the different data services 170 and/or marketplaces 150.

At 610, the method 600 may include generating a seller response message (such as a seller response message 330) based on the linkage identifier and the one or more groups of data records. The seller response message may include a data structure for the one or more groups of data records and the linkage identifier. The seller response message may be encoded using various formats suitable for transmission over the communication network 107. For example, the seller response message may be formatted according to a Javascript Object Notation (JSON) format, an eXtensible Markup Language (XML) format, and/or other types of formats.

In some examples, generating the seller response message may include, for each group of data records: provide data fields from the plurality of data services used to match with the one or more details of the seller and a corresponding indication of whether and to what extent the candidate seller details matched the one or more details of the seller.

In some examples, retrieving the data records may include retrieving a data record from a risk data service (such as data service 170A), the data record comprising information for a candidate seller that has been reported by an acquirer as having one or more risk attributes. In some of these examples, generating the seller response message may include determining a number of partial or full matches between the one or more details of the seller and one or more details of the candidate seller, generating a score based on the number of partial or full matches, and providing the score in a section of the seller response message allocated for the candidate seller.

In some examples, retrieving the data records may include retrieving a data record from an MT data service (such as data service 170B), the data record comprising information for a candidate seller that is registered to accept electronic payments through a payment network (such as payment network 140). In some of these examples, generating the seller response message may include retrieving a confidence level that indicates a level of confidence that the candidate seller is the seller, and providing the score in a section of the seller response message allocated for the candidate seller. The levels of confidence may be bucketed into High, Medium, and Low confidences. It should be noted that the levels of confidence may include quantitative results such as a range of numbers that are segmented to correspond to the High, Medium, Low, and/or other confidence buckets.

In some examples, retrieving the data records may include retrieving a data record from a MI data service (such as data service 170C), the data record comprising recognizable merchant descriptors and/or location information for a candidate seller. In some of these examples, generating the seller response message may include providing the merchant descriptors and/or location information in a section of the seller response message allocated for the candidate seller.

In some examples, retrieving the data records may include retrieving a data record from a TRN data service (such as data service 170N), the data record comprising transaction data indicating purchase transactions of a candidate seller processed by a payment network. In some of these examples, generating the seller response message may include providing one or more transaction metrics based on the transaction data in a section of the seller response message allocated for the candidate seller.

At 612, the method 600 may include transmitting, responsive to the request, the seller response message.

In some examples, the method 600 may further include assigning each group of data records with a probability that the candidate seller associated with the group of data records is the seller, and providing, in the seller response message, only a single group of data records having a highest probability. For example, because each group of data records represents data records from one or more data services that are predicted to relate to the same known seller, the groups of data records may be scored based on respective probabilities that the group of data records relate to the seller to be identified and/or assessed. In some examples, only the top-scoring (highest probability) group of data records may be provided in the seller response message.

In other examples, the method 600 may further include providing, in the seller response message, all of the groups of data records with corresponding probabilities. Whether to provide only a single group of records or all of the group of records may be based on user input that specifies a preference to receive either the single or all groups of records.

In some examples, generating the seller response message may include generating a seller risk assessment based on the grouped data records. In these examples, the recipient of the seller response message (and requester that provided the request) may be a marketplace 150.

In some examples, generating the seller response message may include generating a seller certification based on the grouped data records, the seller certification verifying an identity of the seller. In these examples, the recipient of the seller response message (and requester that provided the request) may be a seller 120 that wishes to obtain such seller certification to be able to provide the seller certification to marketplaces 150 and/or to display such seller certification on an electronic storefront, other marketplace page, and/or physically in a physical brick-and-mortar store.

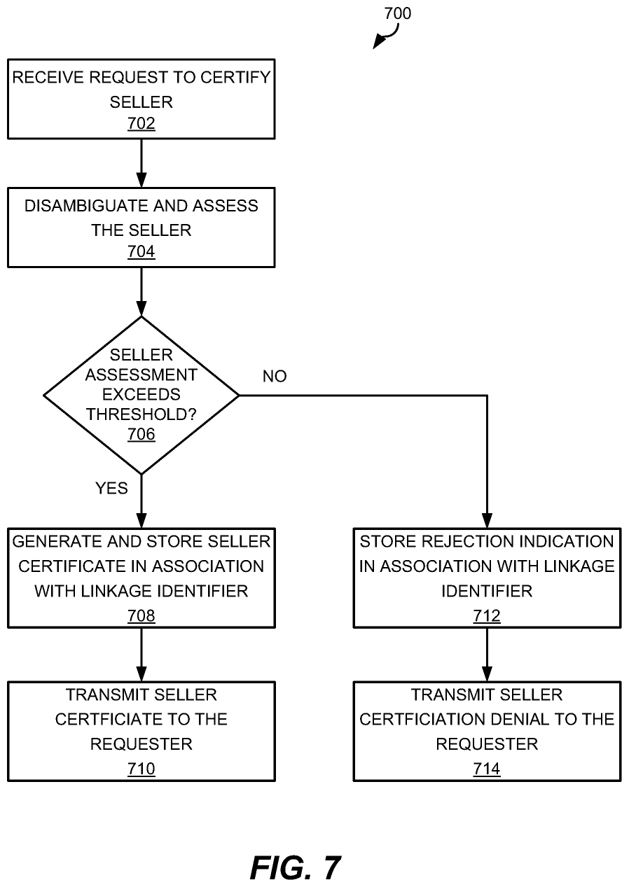

FIG. 7 illustrates an example of a method 700 of processing a request to generate a seller certification. In the method 700 and the methods that follow, reference may be made to FIG. 1. At 702, the method 700 may include receiving a request to certify a seller (such as a seller 120). The request may originate from the seller to obtain seller certification, from a marketplace (such as a marketplace 150) to determine whether any of its sellers or potential sellers can be certified, and/or other entities that wish to obtain a seller certification for a seller.

At 704, the method 700 may include disambiguating and assessing the seller. For example, the orchestrator 190 may generate disambiguate and generate a seller assessment, such as a score, a composite score, an identification of the seller, a confidence in the identification, and/or other metric.

At 706, the method 700 may include determining whether the seller assessment exceeds a predefined threshold. The threshold may be predefined and/or configured based on empirical observations of quality sellers as determined by marketplaces 150 that define successful sellers and/or other entities that may assess seller quality. Thus, the threshold may be informed by, in some instances, machine-learning techniques that may identify relationships between scores or composite scores (or underlying data aggregated by the orchestrator 190) and sellers labeled as being quality sellers. In some examples, a seller classifier may be generated based on the machine-learning techniques. The seller classifier may include a binary classifier that classifies a given seller as being certifiable or not certifiable.

At 708, if the seller assessment exceeds the threshold or the seller is otherwise classified as certifiable, the method 700 may include generating and storing a seller certificate in association with a linkage identifier (such as a linkage identifier 320 illustrated in FIG. 3) for the seller. The seller certificate may include a unique identifier that indicates that the seller has been certified. At 710, the method 700 may include transmitting the seller certificate to the requester.

Returning to 706, if the seller assessment does not exceed the threshold or the seller is otherwise classified as not certifiable, at 712, the method 700 may include storing a rejection indication in association with the linkage identifier of the seller. In this manner, a failed attempt at certification may be stored. In some of these examples, the reasons for the failed certification may be stored as well. At 714, the method 700 may include transmitting a seller certification denial response to the requester.

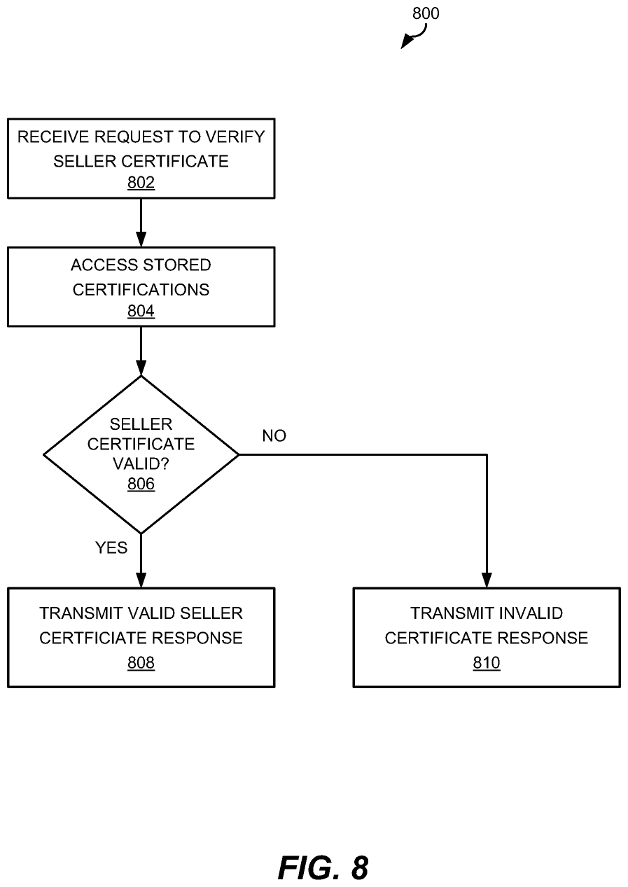

FIG. 8 illustrates an example of a method 800 of processing a request to validate a seller certification. At 802, the method 800 may include receiving a request to verify a seller certificate. For example, a marketplace 150 or customer of the seller may request that the seller certification is valid. At 804, the method 800 may include accessing stored seller certificates. For example, the method 800 may include using the input seller certificate to lookup a database of seller certificates (which may be stored in the seller database 101). At 806, the method 800 may include determining whether the seller certificate is valid. For example, existence of the seller certificate may indicate its validity. In some examples, the seller certificate may expire, in which case the non-expiration of the seller certificate may be verified. In other examples, the seller certificate may not expire. At 808, the method 800 may include transmitting a valid seller certificate response if the seller certificate is valid, or at 810, the method 800 may include transmitting an invalid seller certificate response if the seller certificate is invalid,

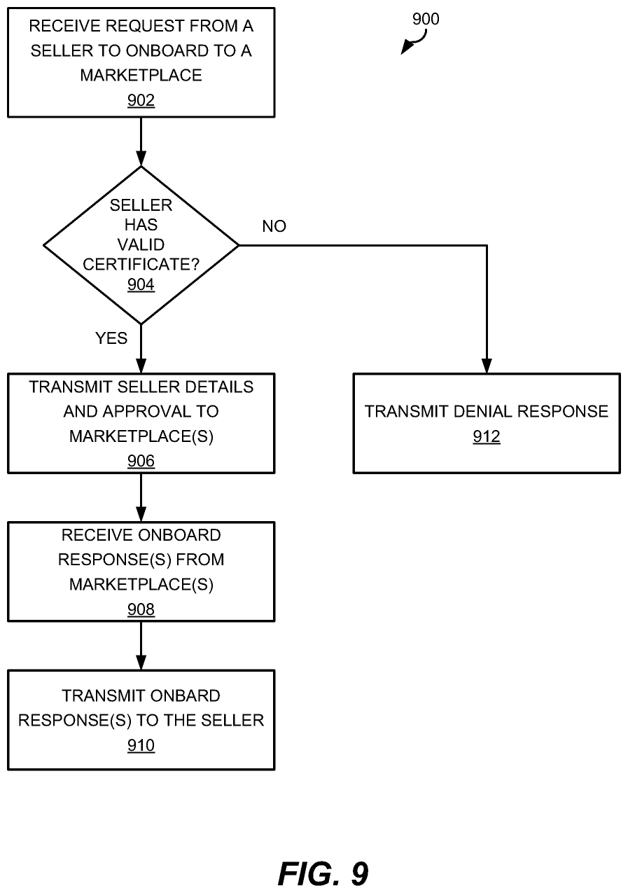

FIG. 9 illustrates an example of a method 900 of processing a request to automatically onboard to a marketplace (such as marketplace 150).

At 902, the method 900 may include receiving a request from a seller to onboard to one or more marketplaces.

At 904, the method 900 may include determining whether the seller has a valid seller certificate (such as through the method 800 illustrated in FIG. 8).

At 906, if the seller has a valid seller certificate, the method 900 may include transmitting seller details and approval to the one or more marketplaces. In some examples, the seller details may include aggregated data, including any scores or other assessments, from a seller response message (such as seller response message 330). In some examples, a marketplace may provide rules or other logic to assess whether to onboard sellers. In these examples, the method 900 may include applying the rules to make the assessment.

At 908, the method 900 may include receiving an onboard response from the one or more marketplaces. At 910, the method 900 may include transmitting the one or more onboarding responses to the seller. Returning to 904, if the seller does not have a valid seller certificate, at 912, the method 900 may include transmitting a denial response to the seller.

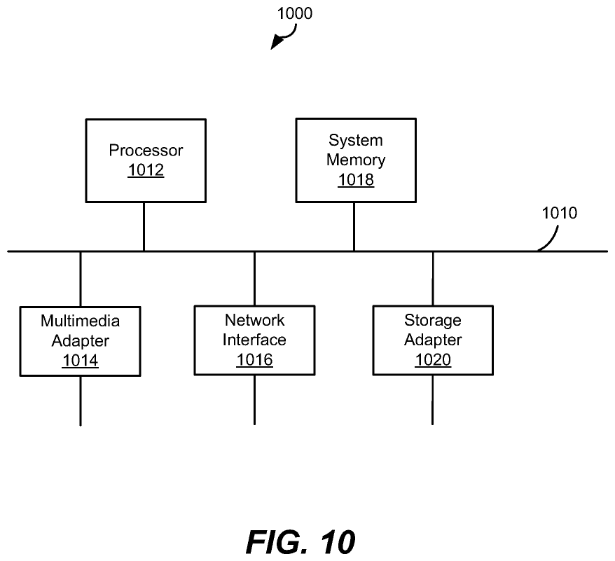

FIG. 10 illustrates an example of a computer system that may be implemented by devices illustrated in FIGS. 1, 3, and 4. The computer system 1000 may be part of or include the system 100 to perform the functions and features described herein. For example, various ones of the devices of system 100 may be implemented based on some or all of the computer system 1000.

The computer system 1000 may include, among other things, an interconnect 1010, a processor 1012, a multimedia adapter 1014, a network interface 1016, a system memory 1018, and a storage adapter 1020.

The interconnect 1010 may interconnect various subsystems, elements, and/or components of the computer system 1000. As shown, the interconnect 1010 may be an abstraction that may represent any one or more separate physical buses, point-to-point connections, or both, connected by appropriate bridges, adapters, or controllers. In some examples, the interconnect 1010 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1010 may allow data communication between the processor 1012 and system memory 1018, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1012 may control operations of the computer system 1000. In some examples, the processor 1012 may do so by executing instructions such as software or firmware stored in system memory 1018 or other data via the storage adapter 1020. In some examples, the processor 1012 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1014 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1016 may provide the computer system 1000 with an ability to communicate with a variety of remove devices over a network such as the communication network 107 illustrated in FIG. 1. The network interface 1016 may include, for example, an Ethernet adapter, a Fibre Channel adapter, and/or other wired- or wireless-enabled adapter. The network interface 1016 may provide a direct or indirect connection from one network element to another, and facilitate communication and between various network elements.

The storage adapter 1020 may connect to a standard computer readable medium for storage and/or retrieval of information, such as a fixed disk drive (internal or external).

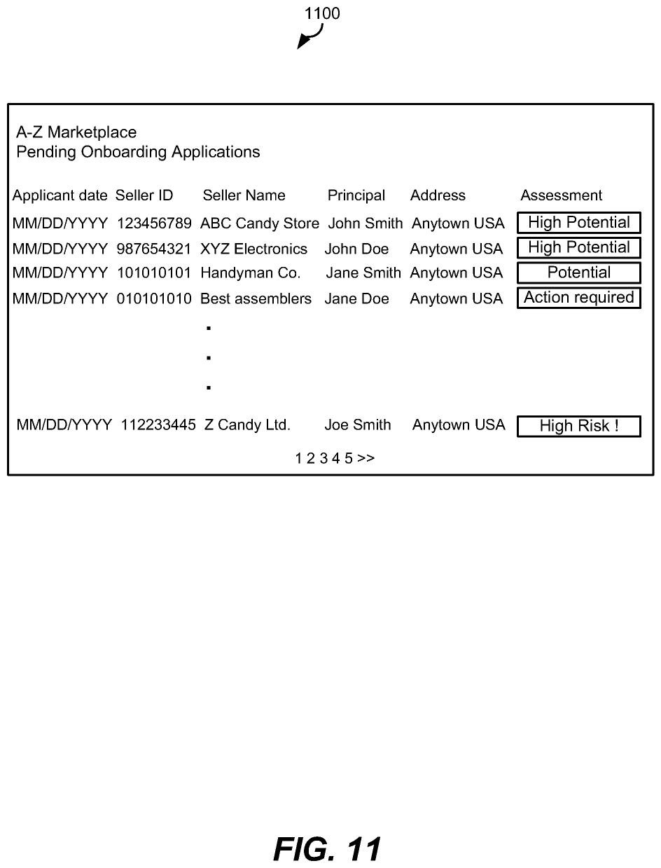

Other devices, components, elements, or subsystems (not illustrated) may be connected in a similar manner to the interconnect 1010 or via a network such as the communication network 107. The devices and subsystems can be interconnected in different ways from that shown in FIG. 11. Instructions to implement various examples and implementations described herein may be stored in computer-readable storage media such as one or more of system memory 1018 or other storage. Instructions to implement the present disclosure may also be received via one or more interfaces and stored in memory. The operating system provided on computer system 1000 may be MS-DOS®, MS-WINDOWS®, OS/2®, OS X®, IOS®, ANDROID®, UNIX®, Linux®, or another operating system.

FIG. 11 illustrates an example of a user interface 1100 to display pending applications of sellers applying to join a marketplace (such as a marketplace 150). The user interface 1100 and other user interfaces 1200-1500 described herein may be generated based on a data from the various APIs such as those illustrated in FIG. 4. It should be noted that the various user interfaces 1100-1500 illustrated herein represent screenshot representations. The particular design, configuration, and appearance are shown for illustrative purposes. As such, the GUI elements as illustrated may be changed, reconfigured, and/or omitted, while other GUI elements not shown may be added.

As illustrated, a user acting on behalf of a marketplace 150 named “A-Z Marketplace” may be provided with the user interface 1100 to assess sellers that have applied to be onboarded to the marketplace 150. The user interface 1100 may provide a listing of sellers, which may each be identified by a seller identifier (ID) and seller name. Other information relating to each seller may be provided as well, such as the principal and address of the seller, and an assessment of the seller (such as an assessment by the orchestrator 190) may be provided. The assessment as illustrated may be provided as a plain language assessment such as “high potential” (highly recommended to onboard) or “high risk.” Such plain language assessments may be based on a numeric or other type of quantitative score that in bucketed into one of the plain language assessments. Selection of any one of the sellers on the user interface 1100 may cause further interfaces to be generated and provided.

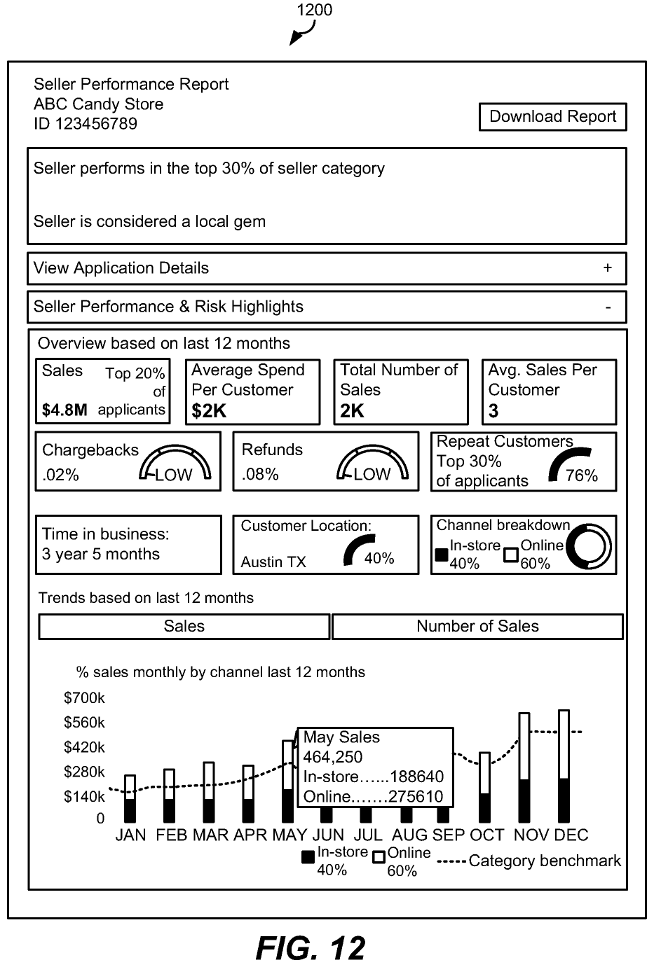

For example, FIG. 12 illustrates an example of a user interface 1200 to display a seller performance report for a high-scoring seller “ABC Candy Store” (such as a seller 120). Different analytics relating to the high-scoring seller that led to the assessment of the “ABC Candy Store” seller may be provided by the user interface 1200, including comparisons to benchmarks such as a seller category benchmark that indicates how the seller compares to sellers in the same category.

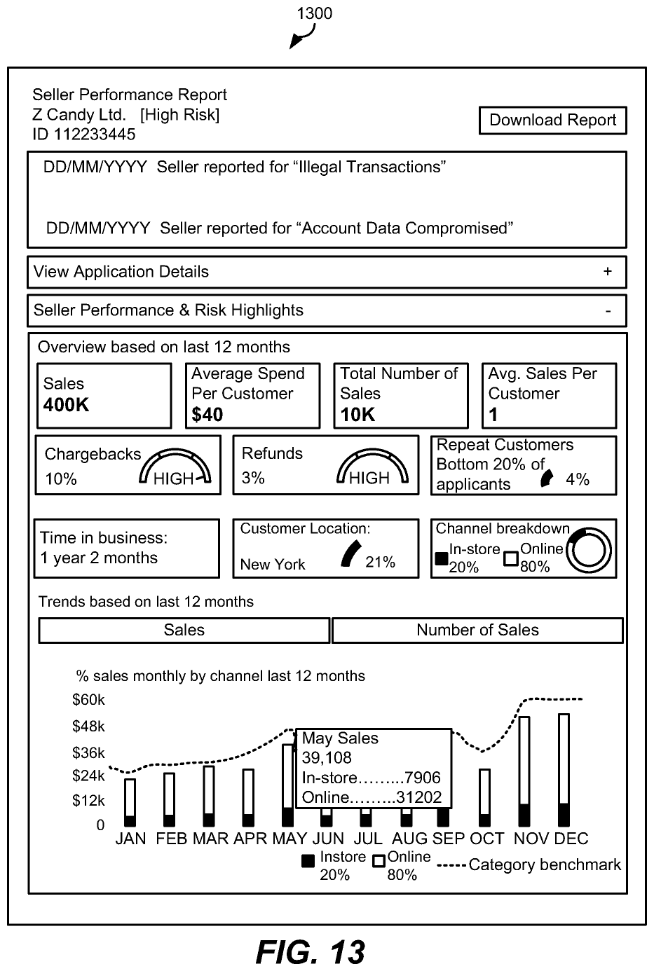

On the other hand, FIG. 13 illustrates an example of a user interface 1300 to display a seller performance report for a low-scoring seller “Z Candy Ltd.” (such as a seller 120). This seller is illustrated as being assessed as a “high risk.” The user interface 1300 may provide reasons for the assessment of high risk for the low-scoring seller and the date in “MM/DD/YYY” format of such reported reasons. Analytics may be provided similar to the analytics of user interface 1200.

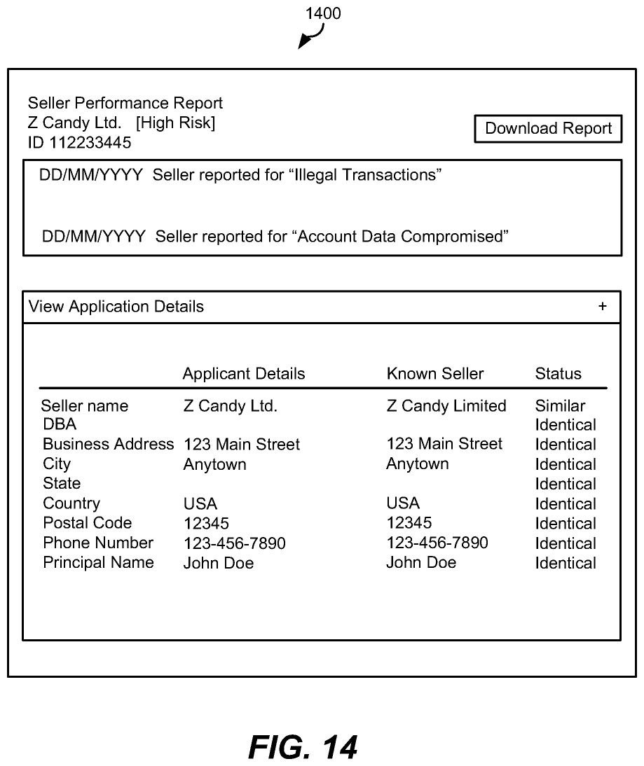

FIG. 14 illustrates an example of a user interface 1400 to display a seller detail report for the low-scoring seller illustrated in FIG. 10. The user interface 1400 may provide application details of the low-scoring seller. The applicant details may include a listing of known details of the low-scoring seller compared to details of a candidate seller for which data is known. For example, the seller name “Z Candy Ltd.” may be partially matched and found to be similar to a candidate seller named “Z Candy Limited.” On this basis, the system may determine that the candidate seller is likely the seller that is applying for onboarding. Other details are illustrated as having exact (or “identical”) matches. Thus, the candidate seller may be deemed to be the seller and information known about the candidate seller may be assumed to relate to the seller. As such, the seller may disambiguate and identify sellers based on partial or exact matches to details of known sellers.

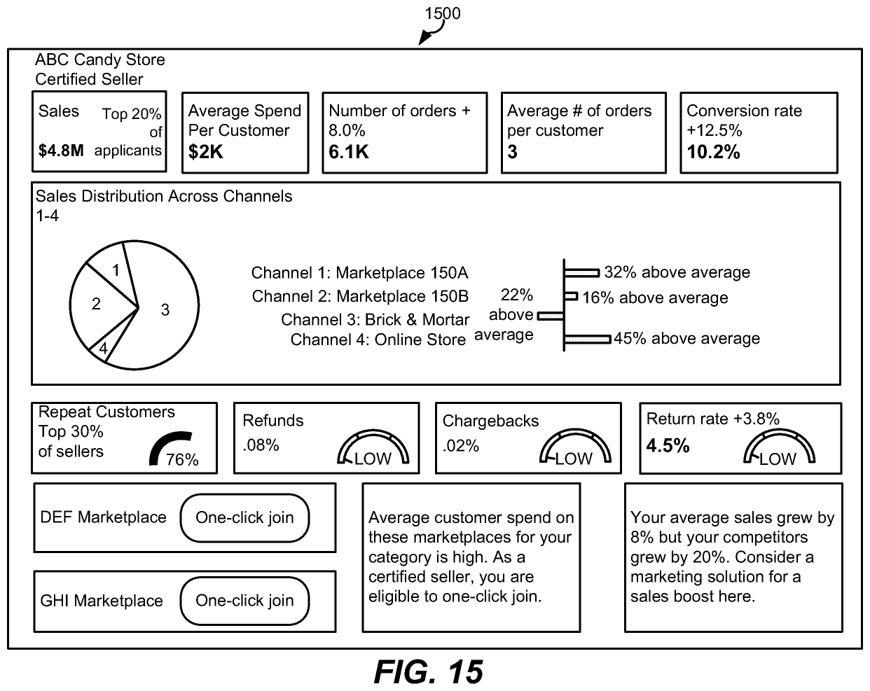

FIG. 15 illustrates an example of a user interface 1500 to display a seller dashboard to be provided to a seller (such as a seller 120). The user interface 1500 may provide analytics relating to the seller performance, including recommendations on how to improve key performance metrics, such as sales. In some examples, if the seller is a certified seller, that seller may be eligible to “one-click join” a marketplace (such as the illustrated “DEF marketplace” and “GHI marketplace”). Upon selection of the one-click join input option, the certified seller may be automatically onboarded onto the corresponding marketplace. Such automatic joining may be facilitated by the method 900 illustrated in FIG. 9.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number.

The databases described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly messages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
receive a request to identify and/or assess a seller, the request comprising one or more details of the seller;
retrieve, from a plurality of data services that each store respective and different data regarding known sellers, data records for candidate sellers, from among the known sellers, having candidate seller details that partially or fully match the one or more details of the seller;
aggregate the data records into one or more groups of data records, each group of data records representing retrieved information, from the plurality of data services, of a respective candidate seller that is potentially the seller;
generate a linkage identifier for the seller and the one or more groups of data records;
generate a seller response message based on the linkage identifier and the one or more groups of data records; and
transmit, responsive to the request, the seller response message.

2. The system of claim 1, wherein to generate the seller response message, the processor is further programmed to:
for each group of data records: provide data fields from the plurality of data services used to match with the one or more details of the seller and a corresponding indication of whether and to what extent the candidate seller details matched the one or more details of the seller.

3. The system of claim 1, wherein a first detail from among the one or more details of the seller partially or fully matches first seller details of a first data service and a second detail from among the one or more details of the seller partially or fully matches second seller details of a second data service.

4. The system of claim 3, wherein the first detail comprises a seller name and the second detail comprises at least a portion of a seller address.

5. The system of claim 1, wherein to retrieve the data records, the processor is further programmed to:
retrieve a data record from a risk data service, the data record comprising information for a candidate seller that has been reported by an acquirer as having one or more risk attributes.

6. The system of claim 5, wherein to generate the seller response message, the processor is further programmed to:
determine a number of partial or full matches between the one or more details of the seller and one or more details of the candidate seller;
generate a score based on the number of partial or full matches; and
provide the score in a section of the seller response message allocated for the candidate seller.

7. The system of claim 1, wherein to retrieve the data records, the processor is further programmed to:
retrieve a data record from a merchant tool data service, the data record comprising information for a candidate seller that is registered to accept electronic payments through a payment network.

8. The system of claim 7, wherein to generate the seller response message, the processor is further programmed to:
retrieve a confidence level that indicates a level of confidence that the candidate seller is the seller; and
provide the confidence level in a section of the seller response message allocated for the candidate seller.

9. The system of claim 1, wherein to retrieve the data records, the processor is further programmed to:
retrieve a data record from a merchant identifier data service, the data record comprising recognizable merchant descriptors and/or location information for a candidate seller.

10. The system of claim 9, wherein to generate the seller response message, the processor is further programmed to:
provide the merchant descriptors and/or location information in a section of the seller response message allocated for the candidate seller.

11. The system of claim 1, wherein to retrieve the data records, the processor is further programmed to:
retrieve a data record from a transactions data service, the data record comprising transaction data indicating purchase transactions of a candidate seller processed by a payment network.

12. The system of claim 11, wherein to generate the seller response message, the processor is further programmed to:
provide one or more transaction metrics based on the transaction data in a section of the seller response message allocated for the candidate seller.

13. The system of claim 1, wherein the processor is further programmed to:
assign each group of data records with a probability that the candidate seller associated with the group of data records is the seller; and
provide, in the seller response message, only a single group of data records having a highest probability.

14. The system of claim 1, wherein the processor is further programmed to:
assign each group of data records with a probability that the candidate seller associated with the group of data records is the seller; and
provide, in the seller response message, all of the groups of data records with corresponding probabilities.

15. The system of claim 1, wherein to generate the seller response message, the processor is further programmed to:
generate a seller risk assessment based on the grouped data records.

16. The system of claim 1, wherein to generate the seller response message, the processor is further programmed to:
generate a seller certification based on the grouped data records, the seller certification verifying an identity of the seller.

17. A method, comprising:
receiving, by a processor, a request to identify and/or assess a seller, the request comprising one or more details of the seller;
retrieving, by the processor, from a plurality of data services that each store respective and different data regarding known sellers, data records for candidate sellers, from among the known sellers, having candidate seller details that partially or fully match the one or more details of the seller;
aggregating, by the processor, the data records into one or more groups of data records, each group of data records representing retrieved information, from the plurality of data services, of a respective candidate seller that is potentially the seller;
generating, by the processor, a linkage identifier for the seller and the one or more groups of data records;
generating, by the processor, a seller response message based on the linkage identifier and the one or more groups of data records; and
transmitting, by the processor, responsive to the request, the seller response message.

18. The method of claim 17, wherein generating the seller response message comprises:
for each group of data records: providing data fields from the plurality of data services used to match with the one or more details of the seller and a corresponding indication of whether and to what extent the candidate seller details matched the one or more details of the seller.

19. The method of claim 17, wherein a first detail from among the one or more details of the seller partially or fully matches first seller details of a first data service and a second detail from among the one or more details of the seller partially or fully matches second seller details of a second data service.

20. The method of claim 19, wherein the first detail comprises a seller name and the second detail comprises at least a portion of a seller address.
